(19) United States
(12) Patent Application Publication
(10) Pub. No.: US 2002/0103268 A1
(43) Pub. Date: Aug. 1, 2002

(54) PROCESS FOR THE PRODUCTION OF RIGID FOAMS CONTAINING URETHANE GROUPS AND PREDOMINANTLY ISOCYANURATE GROUPS

(76) Inventors: ROLF WIEDERMANN, ODENTHAL-VOISWI (DE); STEPHAN WENDEL, LEVERKUSEN (DE); WOLFGANG SCHMITZ, ODENTHAL-BLECHE (DE)

Correspondence Address: BAYER CORPORATION, PATENT DEPARTMENT, 100 BAYER ROAD, PITTSBURGH, PA, 152059741

(21) Appl. No.: 08/362,547

(22) PCT Filed: Jun. 28, 1993
(86) PCT No.: PCT/EP93/01651

(30) Foreign Application Priority Data
Jul. 9, 1992 (DE) P 42 22 519.1

(51) Int. Cl. C08J 9/00

(52) U.S. Cl. 521/131

(57) ABSTRACT

Rigid foams containing urethane groups and predominantly isocyanurate groups are obtained by reaction of

1) polyisocyanates with

2) compounds containing at least two isocyanate-reactive hydrogen atoms and having a molecular weight of 400 to 10,000 in the presence of

3) organic blowing agents and

4) flameproofing agents and

5) compounds containing at least two isocyanate-reactive hydrogen atoms and having a molecular weight of 32 to 399 as crosslinking agent and optionally in the presence of

6) auxiliaries and additives known per se,

using a process in which component 2) has branched chains; component 2), the flameproofing agent 4) and the crosslinking component 5) are used as a formulation in which

component 2) is present in a quantity of 30 to 90 parts by weight,

component 4) is present in a quantity of 10 to 60 parts by weight and

component 5) is present in a quantity of 10 to 20 parts by weight,

the parts by weight of these components adding up to 100, and the reaction is carried out in an index range of 200 to 600.

This invention relates to a process for the production of flameproofed, CFC-free rigid polyisocyanurate foams.

The production of halogen-free rigid polyisocyanurate foams using water and hydrocarbons as blowing agents is known. The use of water as blowing agent has the disadvantage that the formation of polyurea structures (in consequence of the reaction of isocyanate with water accompanied by the elimination of carbon dioxide) turns the surface of the foams brittle (surface brittleness) so that adhesion between the foam and the surface skin is adversely affected.

Although, on the other hand, surface brittleness is reduced by using only hydrocarbons as blowing agent, the percentage content of flameproofing agents which normally act as plasticizers has to be increased to ensure flame resistance, so that purely hydrocarbon-blown rigid foams are generally not dimensionally stable and show shrinkage/contraction.

It has now surprisingly been found that, without any adverse effect on the required flame resistance, purely hydrocarbon-blown rigid polyisocyanurate foams do not shrink providing polyols having branched chains are used.

In the context of the invention, “branched” chains are understood to be linear chains from which one or more side chains branch out; in addition to carbon atoms, heteroatoms may also be present in the linear chain and in the side chain. This definition also encompasses linear chains bearing methyl substituents.

The present invention relates to a process for the production of rigid foams containing urethane groups and predominantly isocyanurate groups by reaction of

1) polyisocyanates with

2) compounds containing at least two isocyanate-reactive hydrogen atoms and having a molecular weight of 400 to 10,000 in the presence of

3) organic blowing agents and

4) flameproofing agents and

5) compounds containing at least two isocyanate-reactive hydrogen atoms and having a molecular weight of 32 to 399 as crosslinking agent and optionally in the presence of

6) auxiliaries and additives known per se,

characterized in that component 2) has branched chains and in that component 2), the flameproofing agent 4) and the crosslinking component 5) are used as a formulation in which

component 2) is present in a quantity of 30 to 90 parts by weight,

component 4) is present in a quantity of 10 to 60 parts by weight and

component 5) is present in a quantity of 10 to 20 parts by weight,

the parts by weight of these components adding up to 100, and in that the reaction is carried out in an index range of 200 to 600.

In preferred embodiments of the invention,

C₁₋₆ hydrocarbons are used as the organic blowing agent,

pentane is used as the organic blowing agent,

cyclopentane is used as the organic blowing agent,

a mixture of 15 to 50% by weight n- and/or isopentane and 85 to 50% by weight cyclopentane is used as the organic blowing agent,

hexane is used as the organic blowing agent,

cyclohexane is used as the organic blowing agent,

mixtures of pentane, cyclopentane, hexane and/or cyclohexane are used as the organic blowing agent.

The following starting components are used for the production of the rigid polyisocyanurate foams:

1. Aliphatic, cycloaliphatic, araliphatic, aromatic and heterocyclic polyisocyanates of the type described for example by W. Siefken in Justus Liebigs Annalen der Chemie, 562, pages 75 to 136, for example those corresponding to the following formula

Q(NCO)ₙ

in which

n=2-4, preferably 2, and

Q is an aliphatic hydrocarbon radical containing 2 to 18 and preferably 6 to 10 carbon atoms, a cycloaliphatic hydrocarbon radical containing 4 to 15 and preferably 5 to 10 carbon atoms, an aromatic hydrocarbon radical containing 6 to 15 and preferably 6 to 13 carbon atoms or an araliphatic hydrocarbon radical containing 8 to 15 and preferably 8 to 13 carbon atoms,

for example polyisocyanates of the type described in DE-OS 28 32 253, pages 10-11.

In general, particular preference is attributed to the polyisocyanates readily obtainable on an industrial scale, for example 2,4- and 2,6-tolylene diisocyanate and mixtures of these isomers (“TDI”) polyphenyl polymethylene polyisocyanates of the type obtained by phosgenation of aniline-formaldehyde condensates (“crude MDI”) and carbodiimide-, urethane-, allophanate-, isocyanurate-, urea- and biuret-modified polyisocyanates (“modified polyisocyanates”), more particularly modified polyisocyanates derived from 2,4- and/or 2,6-tolylene diisocyanate or from 4,4′- and/or 2,4′-diphenylmethane diisocyanate.

2. Other starting components are compounds with branched molecular chains which contain at least two isocyanate-reactive hydrogen atoms and which have a molecular weight of generally 400 to 10,000. In addition to compounds containing amino groups, thiol groups or carboxyl groups, preferred compounds of this type are compounds containing hydroxyl groups, more especially 2 to 8 hydroxyl groups, particularly those having a molecular weight in the range from 1,000 to 8,000 and preferably from 2,000 to 4,000, for example compounds containing at least two, generally two to eight and preferably two to four hydroxyl groups of the type known per se for the production of homogeneous and cellular polyurethanes, as described for example in DE-OS 2 832 253, pages 11 to 18.

This starting component preferably contains up to 50% by weight polyester, based on the mixture as a whole.

3. The blowing agents used are organic blowing agents, preferably C₁₋₆ hydrocarbons, more preferably pentane, especially n- and/or isopentane, also cyclopentane and mixtures thereof with n- and/or isopentane.

4. The flameproofing agents used are flameproofing agents known per se, preferably products liquid at 20° C.

5. Other starting components are compounds containing at least two isocyanate-reactive hydrogen atoms and having a molecular weight in the range from 32 to 399. In this case, too, the compounds in question are compounds containing hydroxyl groups and/or amino groups and/or thiol groups and/or carboxyl groups, preferably compounds containing hydroxyl groups and/or amino groups which serve as crosslinking agents. These compounds generally contain 2 to 8 and preferably 2 to 4 isocyanate-reactive hydrogen atoms. Examples of such compounds can be found in DE-OS 28 32 253, pages 19-20.

6. Auxiliaries and additives known per se, such as emulsifiers and foam stabilizers, are optionally used. Preferred emulsifiers are those based on alkoxylated fatty acids and higher alcohols.

Suitable foam stabilizers are, above all, polyether siloxanes, particularly water-soluble types. These compounds generally have a structure in which a copolymer of ethylene oxide and propylene oxide is attached to a polydimethyl siloxane group. Foam stabilizers such as these are described, for example, in U.S. Pat. Nos. 2,834,748, 2,917,480 and 3,629,308. The catalysts known per se from polyurethane chemistry, such as tert. amines and/or organometallic compounds, may also be used.

Reaction retarders known per se, for example compounds showing an acidic reaction, such as hydrochloric acid or organic acid halides; cell regulators known per se, such as paraffins or fatty alcohols or dimethyl polysiloxanes; pigments or dyes; stabilizers against ageing and weathering; plasticizers; fungistatic and bacteriostatic agents; and fillers, such as barium sulfate, kieselguhr, carbon black or whiting, may also be used.

Further examples of surface-active additives and foam stabilizers, cell regulators, reaction retarders, stabilizers, flameproofing agents, plasticizers, dyes, fillers, fungistatic and bacteriostatic agents which may optionally be used in accordance with the invention and information on the use of these additives and the way in which they work can be found in Kunststoff-Handbuch, Vol. VII, edited by Vieweg and Höchtlen, Carl-Hanser-Verlag, München 1966, for example on pages 103 to 113.

The process according to the invention is carried out as follows:

According to the invention, the reaction components are reacted by the single-stage process known per se, the prepolymer process or the semiprepolymer process, often using machines, for example of the type described in U.S. Pat. No. 2,764,565. Particulars of processing machines which may also be used in accordance with the invention can be found in Kunststoff-Handbuch, Vol. VIII, edited by Vieweg and Höchtlen, Carl-Hanser-Verlag, München 1966, for example on pages 121 to 205.

According to the invention, the reaction is carried out in the index range from 200 to 600 and preferably in the index range from 250 to 450.

According to the invention, foaming may also be carried out in closed molds. To this end, the reaction mixture is introduced into a mold. Suitable mold materials are metals, for example aluminium, or plastics, for example epoxy resin.

The foamable reaction mixture foams in the mold and forms the molding. The in-mold foaming reaction may be carried out in such a way that the molding has a cellular structure at its surface. However, it may also be carried out in such a way that the molding has a compact skin and a cellular core. According to the invention, it is possible in this regard to introduce a foamable reaction mixture into the mold in such a quantity that the foam formed just fills the mold. However, it is also possible to introduce more foamable reaction mixture into the mold than is necessary for filling the interior of the mold with foam. This technique is known as overcharging and is described, for example, in U.S. Pat. Nos. 3,178,490 and 3,182,104.

“External release agents” known per se, such as silicone oils, are often used for in-mold foaming. However, so-called “internal release agents”, as known for example from DE-OSS 2 121 670 and 2 307 589, may also be used, optionally in admixture with external release agents.

However, foams may also be produced by slabstock foaming or by the laminator process known per se.

The rigid foams obtainable in accordance with the invention are used for applications requiring high flame resistance, for example in the building industry, for insulation of the engine compartment of trucks and automobiles, as coating materials with high flame resistance and for the surface insulation of engine hoods as protection against noise.

### EXAMPLES

Starting Products

Polyol A (Comparison):

A mixture (formulation) of the following components was prepared:

100 parts by weight of a polyol mixture, OH value 198, consisting of

45 parts by weight of a polyether, OH value 185, prepared by reaction of ethylene glycol with ethylene oxide

8 parts by weight diethylene glycol, OH value 1060

5 parts by weight of a polyester prepared by reaction of phthalic anhydride with benzyl alcohol and butanol

27 parts by weight of the commercially available flame-proofing agent Disflamoll® DPK (a product of Ciba Geigy Plastics and Additives Co.)

15 parts by weight of a polyester, OH value 200, prepared by reaction of adipic acid and phthalic anhydride with diethylene glycol.

Polyol B (Invention):

A mixture (formulation) of the following components was prepared:

100 parts by weight of a polyol mixture, OH value 168, consisting of:

27 parts by weight of the commercially available flame-proofing agent Disflamoll® DPK (a product of Ciba Geigy Plastics and Additives Co.)

12 parts by weight of a polyether, OH value 880, prepared by reaction of trimethylol propane with propylene oxide

50.5 parts by weight of a polyether, OH value 45, prepared by reaction of trimethylol propane with propylene oxide and ethylene oxide

10.5 parts by weight of a polyether, OH value 380, prepared by reaction of trimethylol propane with propylene oxide.

Polyol C (Invention):

A mixture (formulation) of the following components was prepared:

100 parts by weight of a polyol mixture, OH value 212, consisting of:

27 parts by weight of the commercially available flame-proofing agent Disflamoll® DPK (a product of Ciba Geigy Plastics and Additives Co.)

13 parts by weight of a polyether, OH value 880, prepared by reaction of trimethylol propane with propylene oxide

40 parts by weight of a polyether, OH value 56, prepared by reaction of propylene glycol with propylene oxide

10 parts by weight of a polyether, OH value 380, prepared by reaction of trimethylol propane with propylene oxide

10 parts by weight of a polyester, OH value 370, prepared by reaction of adipic acid, phthalic anhydride, oleic acid and trimethylol propane.

Polyol D (Invention):

A mixture (formulation) of the following components was prepared:

100 parts by weight of a polyol mixture, OH value 215, consisting of:

27 parts by weight of the commercially available flame-proofing agent DEEP (diethyl ethyl phosphonate)

13 parts by weight of a polyester, OH value 370, prepared by reaction of adipic acid, phthalic anhydride, oleic acid and trimethylol propane

10 parts by weight of a polyether, OH value 880, prepared by reaction of trimethylol propane with propylene oxide

25 parts by weight of a polyester, OH value 210, prepared by reaction of adipic anhydride, phthalic anhydride, glycerol and propylene glycol

20 parts by weight of a polyether, OH value 56, prepared by reaction of propylene glycol with propylene oxide

25 parts by weight of a polyester, OH value 300, prepared by reaction of phthalic anhydride with diethylene glycol and ethylene oxide.

TABLE 1
(Comparison)
Formulation in parts by weight

| Comparison Examples | 1 | 2 |
|---|---|---|
| Polyol A | 98 | 98 |
| Dimethyl cyclohexyl amine | 0.14 | 0.18 |
| Potassium acetate solution (1) | 0.54 | 0.7 |
| Cyclopentane | 8 | 12.5 |
| Stabilizer B1605 (Bayer AG) | 2 | 2 |
| Polyisocyanate (crude MDI, Desmodur ® | 103 | 166 |
| 44V20, a product of Bayer AG) | | |
| Index | 219 | 351 |
| Density [kg/in³] | 42 | 39 |
| Adhesion of the paper covering | | |
| layer after 24 hours | Good | Good |
| φ Flame height in small burner | 130 | 120 |
| test DIN 4102 [mm] | | |
| DIN 4102 classification | B2 | B2 |
| Dimensional stability | Shrinkage | (Less) |
| | | Shrinkage |
| Surface brittleness | None | None |

(1) 25% solution in diethylene glycol

The results in Table 1 show that, although surface brittleness can be completely eliminated by using only hydrocarbons as blowing agent in the foaming of polyols having unbranched molecular chains with polyisocyanates to form polyisocyanurate foams, the foams obtained are not dimensionally stable.

TABLE 2
Formulation in parts by weight

| | 1 | 2 | 3 | 4 | 5 |
|---|---|---|---|---|---|
| Examples | | | | | (Comparison) |
| Polyol D | — | — | — | 98 | — |
| Polyol C | — | — | 98 | — | 98 |
| Polyol B | 98 | 98 | — | — | — |
| Dimethyl cyclohexyl amine | 0.36 | 0.45 | 0.36 | 0.36 | 0.36 |
| Potassium acetate solution (1) | 1.4 | 1.75 | 1.4 | 1.4 | 1.2 |
| Stabilizer B1605 (Bayer AG) | 2 | 2 | 2 | 2 | 2 |
| Cyclopentane | 8 | 12.5 | 8.5 | 8.0 | 6.5 |
| Polyisocyanate (crude MDI, | 103 | 166 | 116 | 105 | 70 |
| Desmodur ® 44V20 (Bayer AG) | | | | | |
| Index | 244 | 392 | 223 | 200 | 142 |
| Density [kg/m^{3]} | 42 | 39 | 42 | 42 | 42 |
| Adhesion of the paper covering layer | Good | Good | Good | Good | Good |
| after 24 hours | | | | | |
| Ø Flame height in the small burner test | 135 | 135 | 130 | 135 | 140 |
| acc. to DIN 4102 [mm] | | | | | |
| DIN 4102 classification | B2 | B2 | B2 | B2 | B2 |
| Dimensional stability | No | No | No | Almost no | Shrinkage |
| | shrinkage | shrinkage | shrinkage | shrinkage | |
| Surface brittleness | None | None | None | None | None |

(1) 25% solution in diethylene glycol

The results of Examples 1 to 4 in Table 2 show that the polyols according to the invention achieve a DIN 4102 fire classification of B2 and are dimensionally stable where cyclopentane is used as the blowing agent. Example 5 in the Table shows that indices above 200 have to be applied.

1. A process for the production of rigid foams containing urethane groups and predominantly isocyanurate groups by reaction of
1) polyisocyanates with
2) compounds containing at least two isocyanate-reactive hydrogen atoms and having a molecular weight of 400 to 10,000 in the presence of
3) organic blowing agents and
4) flameproofing agents and
5) compounds containing at least two isocyanate-reactive hydrogen atoms and having a molecular weight of 32 to 399 as crosslinking agent and optionally in the presence of
6) auxiliaries and additives known per se,
characterized in that component 2) has branched chains and in that component 2), the flameproofing agent 4) and the crosslinking component 5) are used as a formulation in which
component 2) is present in a quantity of 30 to 90 parts by weight,
component 4) is present in a quantity of 10 to 60 parts by weight and
component 5) is present in a quantity of 10 to 20 parts by weight,
the parts by weight of these components adding up to 100, and in that the reaction is carried out in an index range of 200 to 600.

2. A process as claimed in claim 1, characterized in that C₁₋₆ hydrocarbons are used as the organic blowing agent.

3. A process as claimed in claims 1 and 2, characterized in that pentane is used as the organic blowing agent.

4. A process as claimed in claims 1 and 2, characterized in that cyclopentane is used as the organic blowing agent.

5. A process as claimed in claims 1 to 4, characterized in that a mixture of 15 to 50% by weight n- and/or isopentane and 85 to 50% by weight cyclopentane is used as the organic blowing agent.

6. A process as claimed in claims 1 and 2, characterized in that hexane is used as the organic blowing agent.

7. A process as claimed in claims 1 and 2, characterized in that cyclohexane is used as the organic blowing agent.

8. A process as claimed in claims 1 and 2, characterized in that mixtures of pentane, cyclopentane, hexane and/or cyclohexane are used as the organic blowing agent.
